(19) United States
(12) Patent Application Publication
(10) Pub. No.: US 2023/0040979 A1
(43) Pub. Date: Feb. 9, 2023

(54) Ceiling Lamp Bracket Assembly Without Free Screws

(71) Applicant: Dong Guan Jia Sheng Lighting Technology Co., Ltd. China, Dong-Guna City (CN)

(72) Inventor: Kevin Hsu, Taichung (TW)

(21) Appl. No.: 17/394,619

(22) Filed: Aug. 5, 2021

(51) Int. Cl. F21V 21/00; F16M 13/02

(52) U.S. Cl. CPC F21V 21/00; F16M 13/027

(57) ABSTRACT

A mounting bracket for a ceiling lamp includes a support frame, a lamp bracket body, and a locking screw. The lamp bracket body is secured to the support frame by the locking screw. The support frame includes a frame body, a locking hook, and a limit locking plate. The limit locking plate has a threaded limit hole. The locking screw includes a nut, a movable section, and a threaded fastening section. The movable section is mounted in the limit hole. The lamp bracket body has a first function portion and a second function portion. The second function portion has a threaded locking hole. In assembly, the first function portion is mounted on the locking hook, and the fastening section is screwed into the locking hole.

### BACKGROUND OF THE INVENTION

### 1. Field of the Invention

The present invention relates to a ceiling lamp or light and, more particularly, to a mounting bracket for a ceiling lamp.

### 2. Description of the Related Art

A conventional ceiling light comprises a wall bracket secured to the ceiling and a lamp body mounted on the wall bracket. The wall bracket has a first end provided with a hook for hooking a first side of the lamp body and a second end provided with free screws for securing a second side of the lamp body. Thus, the lamp body is secured to the wall bracket by the hook and the free screws. However, the lamp body is mounted on the wall bracket by the free screws, and the user has to operate the free screws at a determined height, thereby causing inconvenience to the user in assembling and disassembling the conventional ceiling light. In addition, the user cannot mount the lamp body on the wall bracket when the screw are missed, thereby causing inconvenience to the user. Further, the screws are easily dropped during a period of time, so that the lamp body will probably be detached from the wall bracket, thereby causing danger to the user.

### BRIEF SUMMARY OF THE INVENTION

The primary objective of the present invention is to provide a mounting bracket for a ceiling lamp without using free screws.

In accordance with the present invention, there is provided a mounting bracket comprising mounting bracket comprising a support frame, a lamp bracket body removably mounted on the support frame, and a locking screw mounted on the support frame. The lamp bracket body is secured to the support frame by the locking screw. The support frame includes a frame body, a locking hook mounted on a first side of the frame body, and a limit locking plate mounted on a second side of the frame body. The limit locking plate is provided with a limit hole. The limit hole transversely extends through the limit locking plate. The limit hole has a peripheral wall provided with an internal thread. The locking screw includes a nut, a movable section connected with the nut, and a fastening section connected with the movable section. The movable section has a diameter less than that of the nut and less than that of the fastening section. The movable section is mounted in the limit hole of the limit locking plate. The fastening section has a peripheral face provided with an external thread. The lamp bracket body has a first side provided with a first function portion and a second side provided with a second function portion. The second function portion is provided with a locking hole. The locking hole has a peripheral wall provided with an internal thread. In assembly, the first function portion of the lamp bracket body is mounted on the locking hook of the support frame, and the locking screw extends into the locking hole of the second function portion.

According to the primary advantage of the present invention, the movable section of the locking screw is mounted in the limit hole of the limit locking plate, and the limit locking plate of the support frame limited between the nut and the fastening section of the locking screw, so that the locking screw will not be detached from the limit locking plate of the support frame during the assembling and disassembling process, thereby greatly facilitating the user assembling and disassembling the mounting bracket.

According to another advantage of the present invention, the lamp bracket body is mounted on or removed from the support frame easily and quickly to simplify the assembling and disassembling procedure of the mounting bracket.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a mounting bracket in accordance with the preferred embodiment of the present invention.

FIG. 2 is a partial exploded perspective view of the mounting bracket in accordance with the preferred embodiment of the present invention.

FIG. 3 is a locally enlarged view perspective showing combination of the support frame and the locking screw.

FIG. 4 is an exploded perspective view of the mounting bracket as shown in FIG. 3.

FIG. 5 is another perspective view of the mounting bracket in accordance with the preferred embodiment of the present invention.

FIG. 6 is a partial exploded perspective view of the mounting bracket as shown in FIG. 5.

### DETAILED DESCRIPTION OF THE INVENTION

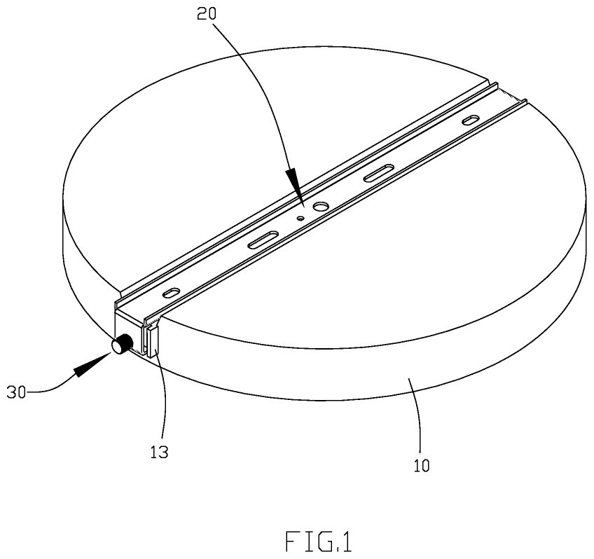

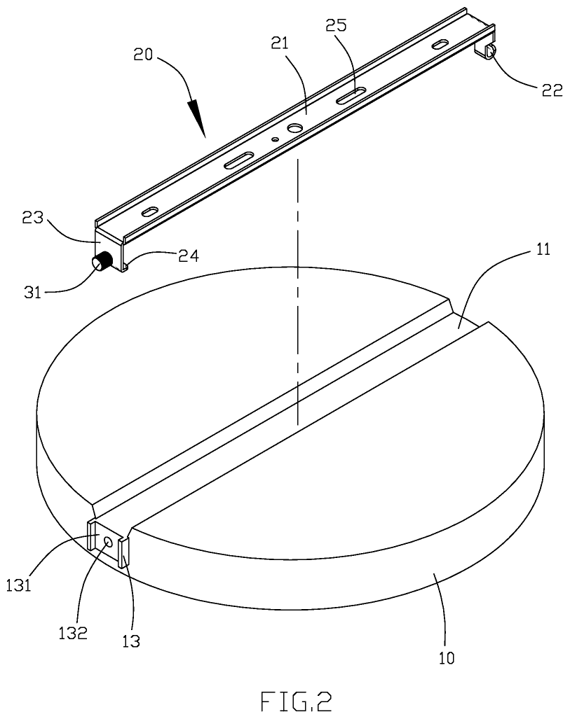

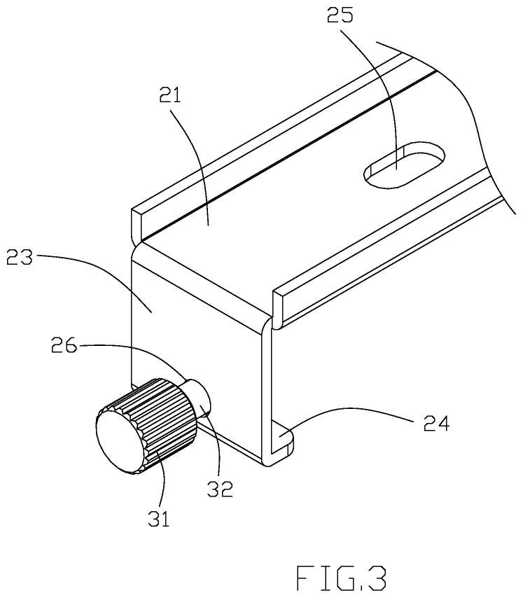

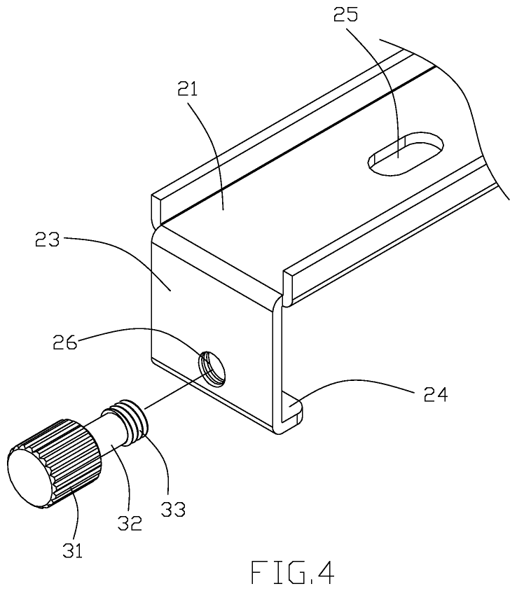

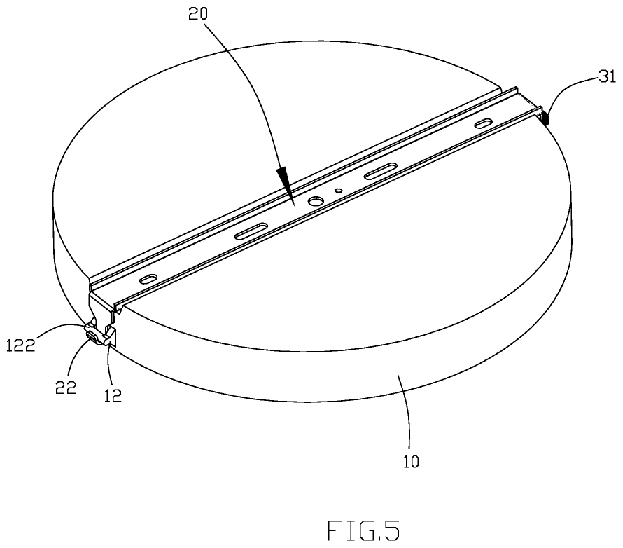

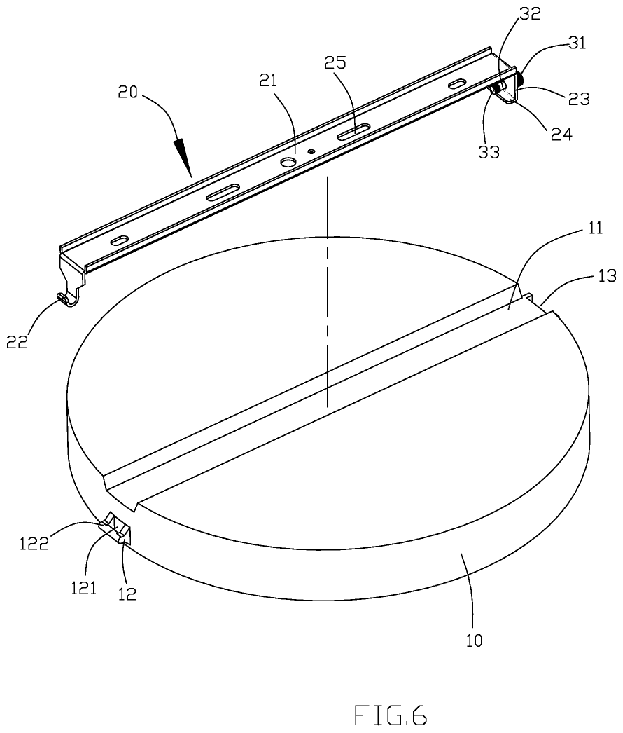

Referring to FIGS. 1-6, a mounting bracket for a ceiling lamp in accordance with the preferred embodiment of the present invention comprises a support frame 20, a lamp bracket body 10 removably mounted on the support frame 20, and a locking screw 30 mounted on the support frame 20. The lamp bracket body 10 is secured to the support frame 20 by the locking screw 30.

The support frame 20 is mounted on a ceiling or a wall. The support frame 20 includes a frame body 21, a locking hook 22 mounted on a first side of the frame body 21, and a limit locking plate 23 mounted on a second side of the frame body 21. The limit locking plate 23 is provided with a limit hole 26. The limit hole 26 transversely extends through the limit locking plate 23. The limit hole 26 has a peripheral wall provided with an internal thread.

The locking screw 30 is mounted on the limit locking plate 23 of the support frame 20 and includes a nut 31, a movable section 32 connected with the nut 31, and a fastening section 33 connected with the movable section 32. The movable section 32 is arranged between the nut 31 and the fastening section 33. The movable section 32 has a diameter less than that of the nut 31 and less than that of the fastening section 33. The movable section 32 is mounted in the limit hole 26 of the limit locking plate 23. The fastening section 33 has a peripheral face provided with an external thread.

In assembly, when the locking screw 30 is to be mounted on the limit locking plate 23 of the support frame 20, the locking screw 30 is rotated, so that the fastening section 33 of the locking screw 30 is screwed into the limit hole 26 of the limit locking plate 23. After the fastening section 33 of the locking screw 30 passes through the limit hole 26 of the limit locking plate 23, the movable section 32 of the locking screw 30 is mounted in the limit hole 26 of the limit locking plate 23, and the limit locking plate 23 of the support frame 20 limited between the nut 31 and the fastening section 33 of the locking screw 30, so that the locking screw 30 will not be detached from the limit locking plate 23 of the support frame 20.

The lamp bracket body 10 has a first side provided with a first function portion 12 and a second side provided with a second function portion 13. The second function portion 13 is provided with a locking hole 132. The locking hole 132 has a peripheral wall provided with an internal thread.

In assembly, the first function portion 12 of the lamp bracket body 10 is mounted on the locking hook 22 of the support frame 20, and the locking screw 30 extends into the locking hole 132 of the second function portion 13 to secure the second function portion 13 of the lamp bracket body 10 to the limit locking plate 23 of the support frame 20.

In the preferred embodiment of the present invention, the lamp bracket body 10 has a circular shape and has a top provided with a mounting channel 11. The mounting channel 11 extends through a whole diameter of the lamp bracket body 10. The first function portion 12 and the second function portion 13 are arranged at two opposite ends of the mounting channel 11.

In the preferred embodiment of the present invention, the locking hook 22 has an upper end secured to the frame body 21. The locking hook 22 has a lower end bent outward and upward. The first function portion 12 is provided with a first retaining groove 121 and a retaining shaft 122. The retaining shaft 122 is arranged in the first retaining groove 121. The lower end of the locking hook 22 passes through the first retaining groove 121 and is hooked on the retaining shaft 122.

In the preferred embodiment of the present invention, the second function portion 13 is provided with a second retaining groove 131. The locking hole 132 of the second function portion 13 is formed in a sidewall of the second retaining groove 131.

In the preferred embodiment of the present invention, the limit locking plate 23 of the support frame 20 has a bottom formed with a stop portion 24. The stop portion 24 of the limit locking plate 23 is bent inward and arranged horizontally. The stop portion 24 of the limit locking plate 23 is locked in the second retaining groove 131 of the second function portion 13.

In the preferred embodiment of the present invention, the frame body 21 is provided with a plurality of mounting slots 25. Each of the mounting slots 25 extends vertically through a whole thickness of the frame body 21.

In the preferred embodiment of the present invention, the second retaining groove 131 vertically extends through a whole height of the second function portion 13.

In the preferred embodiment of the present invention, the frame body 21 and the locking hook 22 are formed integrally.

In another preferred embodiment of the present invention, the locking hook 22 is secured to the frame body 21 by fasteners.

In the preferred embodiment of the present invention, the frame body 21 and the limit locking plate 23 are formed integrally.

In another preferred embodiment of the present invention, the limit locking plate 23 is secured to the frame body 21 by fasteners.

In assembly, when the lamp bracket body 10 is to be mounted on the support frame 20, the first function portion 12 of the lamp bracket body 10 is secured on the locking hook 22 of the support frame 20, with the lower end of the locking hook 22 passing through the first retaining groove 121 and hooked on the retaining shaft 122, so that the first function portion 12 of the lamp bracket body 10 is retained by the locking hook 22 of the support frame 20. Then, the second function portion 13 of the lamp bracket body 10 is pushed toward the limit locking plate 23 of the support frame 20, with the locking hole 132 of the second function portion 13 aligning with the fastening section 33 of the locking screw 30, with the stop portion 24 of the limit locking plate 23 being locked in the second retaining groove 131 of the second function portion 13, and with the frame body 21 of the support frame 20 being locked in the mounting channel 11 of the lamp bracket body 10. Then, the locking screw 30 is rotated, and the fastening section 33 of the locking screw 30 is screwed into the locking hole 132 of the second function portion 13, so that the second function portion 13 of the lamp bracket body 10 is secured to the limit locking plate 23 of the support frame 20 by the locking screw 30. Thus, the lamp bracket body 10 is mounted on and secured to the support frame 20.

On the contrary, when the lamp bracket body 10 is to be removed from the support frame 20, the locking screw 30 is rotated reversely, and the fastening section 33 of the locking screw 30 is unscrewed from the locking hole 132 of the second function portion 13, so that the second function portion 13 of the lamp bracket body 10 is unlocked from the limit locking plate 23 of the support frame 20 by loosening the locking screw 30. Then, the lamp bracket body 10 is pivoted about the retaining shaft 122. Then, the first function portion 12 of the lamp bracket body 10 is pushed upward to detach the locking hook 22 from the first retaining groove 121 and the retaining shaft 122, so that the first function portion 12 of the lamp bracket body 10 is unlocked and removed from the locking hook 22 of the support frame 20. Thus, the lamp bracket body 10 is removed from the support frame 20.

Accordingly, the movable section 32 of the locking screw 30 is mounted in the limit hole 26 of the limit locking plate 23, and the limit locking plate 23 of the support frame 20 limited between the nut 31 and the fastening section 33 of the locking screw 30, so that the locking screw 30 will not be detached from the limit locking plate 23 of the support frame 20 during the assembling and disassembling process, thereby greatly facilitating the user assembling and disassembling the mounting bracket. In addition, the lamp bracket body 10 is mounted on or removed from the support frame 20 easily and quickly to simplify the assembling and disassembling procedure of the mounting bracket.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1: A mounting bracket comprising:
a support frame;
a lamp bracket body removably mounted on the support frame; and
a locking screw mounted on the support frame;
wherein:
the lamp bracket body is secured to the support frame by the locking screw;
the support frame includes a frame body, a locking hook mounted on a first side of the frame body, and a limit locking plate mounted on a second side of the frame body;
the limit locking plate is provided with a limit hole;
the limit hole transversely extends through the limit locking plate;
the limit hole has a peripheral wall provided with an internal thread;
the locking screw includes a nut, a movable section connected with the nut, and a fastening section connected with the movable section;
the movable section has a diameter less than that of the nut and less than that of the fastening section;
the movable section is movably mounted in the limit hole of the limit locking plate;
movement of the movable section in the limit hole of the limit locking plate is limited by the nut and the fastening section;
the fastening section has a peripheral face provided with an external thread;
the lamp bracket body has a first side provided with a first function portion and a second side provided with a second function portion;
the second function portion is provided with a locking hole;
the locking hole has a peripheral wall provided with an internal thread;
the first function portion of the lamp bracket body is mounted on the locking hook of the support frame; and
the locking screw extends into the locking hole of the second function portion.

2: The mounting bracket as claimed in claim 1, wherein the lamp bracket body has a top provided with a mounting channel having a constant width extending through a whole diameter of the lamp bracket body, and the first function portion and the second function portion are arranged at two opposite ends of the mounting channel.

3: The mounting bracket as claimed in claim 1, wherein:
the locking hook has an upper end secured to the frame body;
the locking hook has a lower end bent outward and upward;
the first function portion is provided with a first retaining groove and a retaining shaft;
the retaining shaft is arranged in the first retaining groove; and
the lower end of the locking hook passes through the first retaining groove and is hooked on the retaining shaft.

4: The mounting bracket as claimed in claim 3, wherein the second function portion is provided with a second retaining groove, and the locking hole of the second function portion is formed in a sidewall of the second retaining groove.

5: The mounting bracket as claimed in claim 4, wherein:
the limit locking plate of the support frame has a bottom formed with a stop portion;
the stop portion of the limit locking plate is bent inward and arranged horizontally; and
the stop portion of the limit locking plate is inserted into and locked in the second retaining groove of the second function portion.

6: The mounting bracket as claimed in claim 1, wherein the frame body is provided with a plurality of mounting slots, and each of the mounting slots extends vertically through a whole thickness of the frame body.

7: The mounting bracket as claimed in claim 1, wherein the movable section of the locking screw has a smooth face.

8: The mounting bracket as claimed in claim 1, wherein the movable section of the locking screw is arranged between the nut and the fastening section.

9: The mounting bracket as claimed in claim 1, wherein the locking screw is movable relative to the limit locking plate between a first position where the nut of the locking screw rests on a first side of the limit locking plate and a second position where the fastening section of the locking screw rests on a second side of the limit locking plate so that the locking screw is limited on the limit locking plate by restriction of the nut and the fastening section.

10: The mounting bracket as claimed in claim 1, wherein the fastening section of the locking screw is screwed into the locking hole of the second function portion.

11: The mounting bracket as claimed in claim 1, wherein the diameter of the movable section of the locking screw is less than that of the locking hole of the lamp bracket body.

12: The mounting bracket as claimed in claim 1, wherein the movable section of the locking screw is movable in the limit hole of the limit locking plate with the fastening section of the locking screw protruding from the limit hole of the limit locking plate.
